(19) United States
(12) Patent Application Publication
(10) Pub. No.: US 2024/0129933 A1
(43) Pub. Date: Apr. 18, 2024

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP); Weiqi Sun, Beijing (CN); Jing Wang, Beijing (CN); Lan Chen, Beijing (CN)

(73) Assignee: NTT DOCOMO, INC., Tokyo (JP)

(21) Appl. No.: 18/553,924

(22) PCT Filed: Apr. 5, 2021
(86) PCT No.: PCT/JP2021/014549

§ 371 Date: Oct. 4, 2023

(51) Int. Cl. H04W 72/232; H04B 7/06; H04W 72/1273; H04W 76/20

(52) U.S. Cl. CPC H04W 72/232; H04B 7/06968; H04W 72/1273; H04W 76/20

(57) ABSTRACT

One aspect of a terminal according to the present disclosure includes a receiving section that receives a plurality of downlink control channels supporting application of different control resource set pool indices, and a control section that, when an offset between at least one of the plurality of downlink control channels and a physical shared channel scheduled by the plurality of downlink control channels is smaller than a given value, controls reception of the physical shared channel, based on a default TCI state configured for each of control resource set pool indices or the default TCI state configured irrespective of control resource set pool indices.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+(plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (for example, Rel. 17 or later versions, Beyond 5G/6G or later versions), it is assumed that one or a plurality of transmission/reception points (TRPs) (multi-TRP) perform DL transmission (for example, PDSCH transmission) to a terminal (user terminal, User Equipment (UE)) by using one or a plurality of panels (multi-panel).

In this case, it is assumed that repetition transmission (for example, repetition) is applied to a given channel (for example, a PDCCH). For example, it is considered that scheduling of DL transmission/UL transmission (for example, one PDSCH/PUSCH) is controlled using a plurality of PDCCHs to which repetition transmission (for example, repetition) is applied from the multi-panel/TRP.

However, in existing systems (for example, Rel. 16 or earlier versions), how to control scheduling of a PDSCH/PUSCH using a PDCCH/DCI repeatedly transmitted from one or more TRPs has not been fully studied yet.

In view of this, the present disclosure has one object to provide a terminal, a radio communication method, and a base station with which communication can be appropriately performed even when scheduling is performed using a PDCCH/DCI repeatedly transmitted from one or more TRPs.

### Solution to Problem

A terminal according to one aspect of the present disclosure includes a receiving section that receives a plurality of downlink control channels supporting application of different control resource set pool indices, and a control section that, when an offset between at least one of the plurality of downlink control channels and a physical shared channel scheduled by the plurality of downlink control channels is smaller than a given value, controls reception of the physical shared channel, based on a default TCI state configured for each of control resource set pool indices or the default TCI state configured irrespective of control resource set pool indices.

### Advantageous Effects of Invention

According to one aspect of the present disclosure, communication can be appropriately performed even when scheduling is performed using a PDCCH/DCI repeatedly transmitted from one or more TRPs.

### BRIEF DESCRIPTION OF DRAWINGS

FIG. 1A to FIG. 1D are each a diagram to show an example of a multi-TRP scenario.

FIG. 2 is a diagram to show an example of a case in which a PDSCH is scheduled using PDCCH repetition.

FIG. 3 is a diagram to show an example of a MAC CE used for activation of TCI states.

FIG. 4 is a diagram for illustrating the TCI state to be applied to the PDSCH scheduled by PDCCH repetition.

FIG. 5A to FIG. 5C are each a diagram to show an example of the MAC CE according to a first aspect.

FIG. 6A to FIG. 6C are each a diagram to show an example of the MAC CE according to a second aspect.

FIG. 7A and FIG. 7B are each a diagram to show an example of mapping between TCI code points and TCI state IDs according to the second aspect.

FIG. 8A to FIG. 8C are each a diagram to show an example of the MAC CE according to a third aspect.

FIG. 9A and FIG. 9B are each a diagram to show another example of the MAC CE according to variation 1.

FIG. 10 is a diagram to show an example of the TCI state to be applied to the PDSCH according to variation 2.

FIG. 11 is a diagram for illustrating a scheduling offset between the PDCCH repetition and the PDSCH.

FIG. 12 is a diagram for illustrating a default TCI/QCL to be applied to the PDSCH according to a fourth aspect.

FIG. 13 is a diagram for illustrating the default TCI/QCL to be applied to the PDSCH according to the fourth aspect.

FIG. 14 is a diagram to show an example of a schematic structure of a radio communication system according to one embodiment.

FIG. 15 is a diagram to show an example of a structure of a base station according to one embodiment.

FIG. 16 is a diagram to show an example of a structure of a user terminal according to one embodiment.

FIG. 17 is a diagram to show an example of a hardware structure of the base station and the user terminal according to one embodiment.

### DESCRIPTION OF EMBODIMENTS

(Multi-TRP)

In NR, a scheme in which one or a plurality of transmission/reception points (TRPs) (multi-TRP) perform DL transmission to the UE by using one or a plurality of panels (multi-panel) has been under study. A scheme in which the UE performs UL transmission to one or a plurality of TRPs has been under study as well.

Note that the plurality of TRPs may correspond to the same cell identifier (ID), or may correspond to different cell IDs. The cell ID may be a physical cell ID, or may be a virtual cell ID.

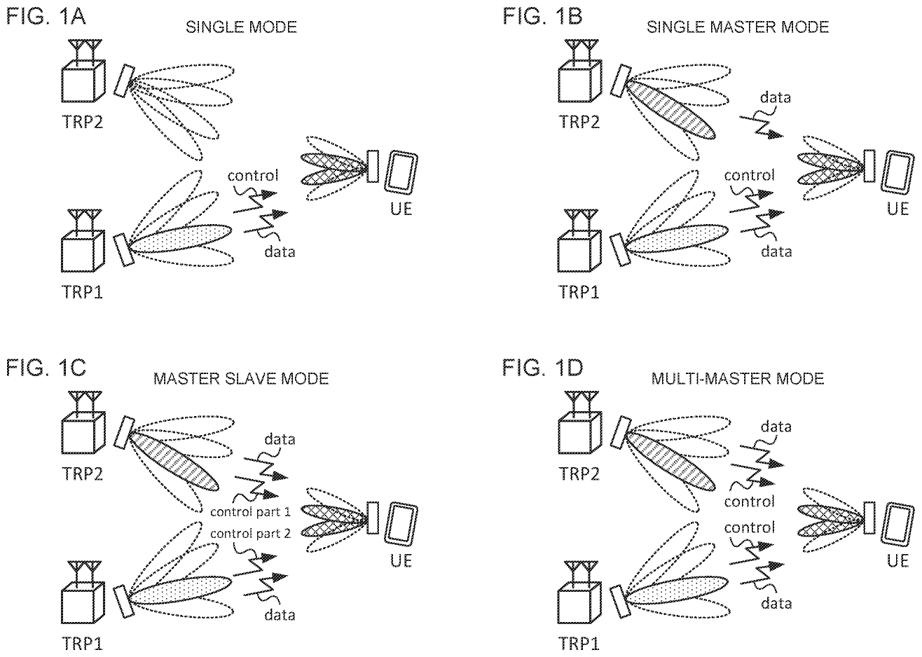

FIGS. 1A to 1D are each a diagram to show an example of a multi-TRP scenario. In these examples, it is assumed that each TRP can transmit four different beams. However, this is not restrictive.

FIG. 1A shows an example of a case (which may be referred to as a single mode, a single TRP, or the like) in which only one TRP (in the present example, TRP 1) out of the multi-TRP performs transmission to the UE. In this case, TRP 1 transmits both of a control signal (PDCCH) and a data signal (PDSCH) to the UE.

FIG. 1B shows an example of a case (which may be referred to as a single master mode) in which only one TRP (in the present example, TRP 1) out of the multi-TRP transmits a control signal to the UE, and the multi-TRP transmits a data signal thereto. The UE receives each PDSCH transmitted from the multi-TRP, based on one downlink control information (DCI).

FIG. 1C shows an example of a case (which may be referred to as a master slave mode) in which each of the multi-TRP transmits a part of a control signal to the UE, and the multi-TRP transmits a data signal thereto. In TRP 1, part 1 of a control signal (DCI) may be transmitted, and in TRP 2, part 2 of the control signal (DCI) may be transmitted. Part 2 of the control signal may depend on part 1. The UE receives each PDSCH transmitted from the multi-TRP, based on these parts of the DCI.

FIG. 1D shows an example of a case (which may be referred to as a multi-master mode) in which each of the multi-TRP transmits different control signals to the UE, and the multi-TRP transmits a data signal thereto. In TRP 1, a first control signal (DCI) may be transmitted, and in TRP 2, a second control signal (DCI) may be transmitted. The UE receives each PDSCH transmitted from the multi-TRP, based on these DCIs.

When a plurality of PDSCHs (which may be referred to as multi-PDSCH (multiple PDSCHs)) from the multi-TRP as shown in FIG. 1B are scheduled using one DCI, the DCI may be referred to as single DCI (S-DCI, single PDCCH). When a plurality of PDSCHs from the multi-TRP as shown in FIG. 1D are each scheduled using a plurality of DCIs, the plurality of DCIs may be referred to as multi-DCI (M-DCI, multi-PDCCH (multiple PDCCHs)).

From each TRP of the multi-TRP, codewords (Code Words (CWs)) and layers different from one another may be transmitted. As one mode of multi-TRP transmission, non-coherent joint transmission (NCJT) has been under study.

In NCJT, for example, TRP 1 subjects a first codeword to modulation mapping and then layer mapping so as to transmit a first PDSCH by using a first number of layers (for example, two layers) by means of first precoding. TRP 2 subjects a second codeword to modulation mapping and then layer mapping so as to transmit a second PDSCH by using a second number of layers (for example, two layers) by means of second precoding.

Note that it may be defined that a plurality of PDSCHs (multi-PDSCH) to be transmitted using NCJT partially or entirely overlap regarding at least one of the time and frequency domains. In other words, at least one of the time and frequency resources of the first PDSCH from the first TRP and the second PDSCH from the second TRP may overlap.

It may be assumed that the first PDSCH and the second PDSCH are not in a quasi-co-location (QCL) relationship (not quasi-co-located). Reception of the multi-PDSCH may be interpreted as simultaneous reception of the PDSCHs that are not of a given QCL type (for example, QCL type D).

In URLLC for the multi-TRP, support of PDSCH (transport block (TB) or codeword (CW)) repetition across the multi-TRP has been under study. Support of repetition schemes across the multi-TRP (URLLC schemes, for example, schemes 1, 2a, 2b, 3, and 4) in the frequency domain, the layer (space) domain, or the time domain has been under study. In scheme 1, the multi-PDSCH from the multi-TRP is subjected to space division multiplexing (SDM). In schemes 2a and 2b, the PDSCH from the multi-TRP is subjected to frequency division multiplexing (FDM). In scheme 2a, a redundancy version (RV) is the same for the multi-TRP. In scheme 2b, the RV may be the same or may be different for the multi-TRP. In schemes 3 and 4, the multi-PDSCH from the multi-TRP is subjected to time division multiplexing (TDM). In scheme 3, the multi-PDSCH from the multi-TRP is transmitted in one slot. In scheme 4, the multi-PDSCH from the multi-TRP is transmitted in different slots.

According to the multi-TRP scenario as described above, more flexible transmission control using a channel with satisfactory quality can be performed.

NCJT using multi-TRP/panel may use a high rank. In order to support ideal and non-ideal backhauls among a plurality of TRPs, both of the single DCI (single PDCCH; for example, FIG. 1B) and the multi-DCI (multi-PDCCH; for example, FIG. 1D) may be supported. For both of the single DCI and the multi-DCI, the maximum number of TRPs may be 2.

For single PDCCH design (mainly for the ideal backhaul), enhancement of the TCI has been under study. Each TCI code point in the DCI may correspond to one or two TCI states. The size of a field related to the TCI state may be the same as that of Rel. 15.

(PDCCH/DCI Repetition)

In Rel. 17 or later versions, it is assumed that repetition transmission (PDCCH repetition) may be applied to the PDCCH(s) (or the DCI(s)) transmitted from one or more TRPs. For example, it is considered that scheduling or transmission and reception indication for one or more signals/channels is performed using a plurality of PDCCHs (or DCIs) transmitted from one or more TRPs.

The PDCCHs/DCIs to which the repetition transmission is applied may be referred to as multi-PDCCH/multi-DCI. The repetition transmission of the PDCCHs may be interpreted as PDCCH repetition, a plurality of transmissions of the PDCCH, multi-PDCCH transmission, or multiple PDCCH transmissions.

The multi-PDCCH/multi-DCI may be respectively transmitted from different TRPs. Such different TRPs may correspond to different CORESET pool indices (hereinafter also referred to as CORESET pool IDs), for example.

The multi-PDCCH/DCI may be multiplexed using time multiplexing (TDM)/frequency multiplexing (FDM)/spatial multiplexing (SDM). For example, when the PDCCH repetition (TDM PDCCH repetition) is performed using time multiplexing, the PDCCHs respectively transmitted from different TRPs are allocated to different time domains.

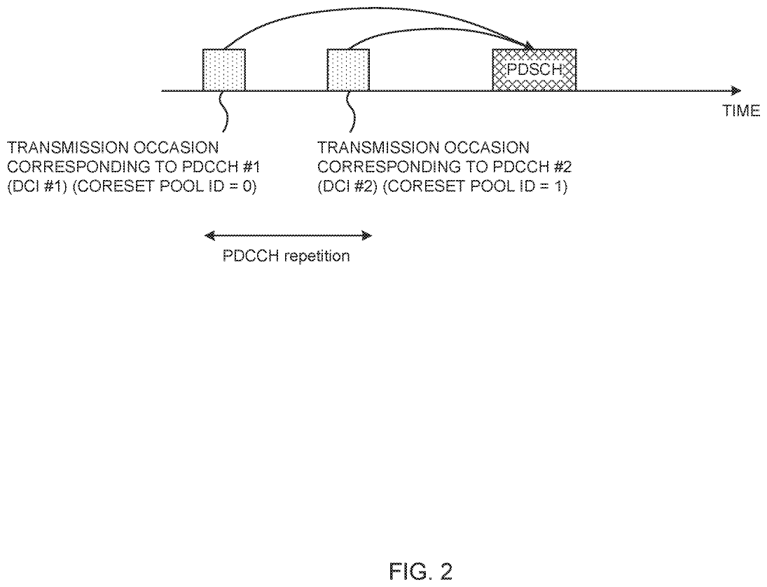

FIG. 2 shows an example of a case in which scheduling of one PDSCH (for example, the same PDSCH) is performed with repetition transmissions of the PDCCHs. A case in which PDCCH #1 is used for transmission of DCI #1 and corresponds to a first CORESET pool ID (here, #0) is shown. A case in which PDCCH #2 is used for transmission of DCI #2 and corresponds to a second CORESET pool ID (here, #1) is shown. Here, a case in which the number of repetitions (or a repetition factor) of the PDCCHs is 2 is shown. However, the number of repetitions may be three or more.

Details of the DCI (for example, DCI payload/coded bits/number of CCEs) transmitted on respective PDCCHs may have the same configuration. Note that coding/rate matching of each DCI may be controlled based on each repetition.

The repeatedly transmitted PDCCHs (for example, PDCCH #1 and PDCCH #2) may be referred to as PDCCH candidates. The PDCCH candidates are explicitly associated (or linked), and the UE may recognize the linkage between the PDCCH candidates (or the associated PDCCH candidates) before performing decoding processing.

For the PDCCH repetition, an association (or a linkage) between a plurality of (for example, two) search space sets may be configured by higher layer signaling/MAC CE. Two search space sets may correspond to CORESETs corresponding to respective repetition transmissions. The CORESETs used for PDCCH repetition may correspond to two CORESETs associated with two linked search space sets.

In the PDCCH repetition, two PDCCH candidates in two search spaces may be linked to have the same aggregation level (AL) and the same candidate index. The two linked search space sets may include the same number of candidates for each AL. In other words, two linked PDCCH candidates for PDCCH repetition may be two PDCCH candidates having the same aggregation level (AL) and the same index in two linked search space sets.

(Activation of TCI State by MAC CE)

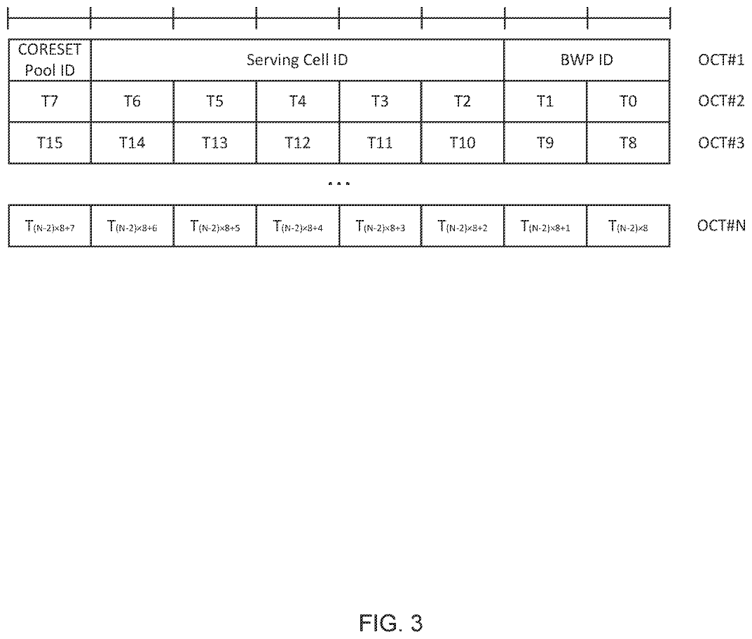

In existing systems (for example, Rel. 16 or earlier versions), when the CORESET pool IDs are configured, the TCI states of the PDSCH is activated for each CORESET pool ID (for example, TRP). In other words, the MAC CE used for reporting of activation of the TCI states is associated with each CORESET pool ID (for example, TRP) (see FIG. 3).

In the MAC CE shown in FIG. 3, a case is assumed in which the CORESET pool ID is configured to 1. In this case, mapping between activated TCI states and code points of the field for the TCI state included in the DCI specified by the MAC CE may be applied to the PDSCH scheduled to have the CORESET pool ID of 1.

In the MAC CE shown in FIG. 3, a case is assumed in which the CORESET pool ID is configured to 1. In this case, mapping between activated TCI states and code points of the field for the TCI state in the DCI indicated by the MAC CE may be applied to the PDSCH scheduled to have the CORESET pool ID of 1.

In the MAC CE shown in FIG. 3, a case is assumed in which the CORESET pool ID is configured to 0. In this case, mapping between activated TCI states and code points of the field for the TCI state in the DCI indicated by the MAC CE may be applied to the PDSCH scheduled to have the CORESET pool ID of 0.

In this manner, in the existing systems, lists of the TCI states (here, two TCI state lists) are configured for each CORESET pool ID.

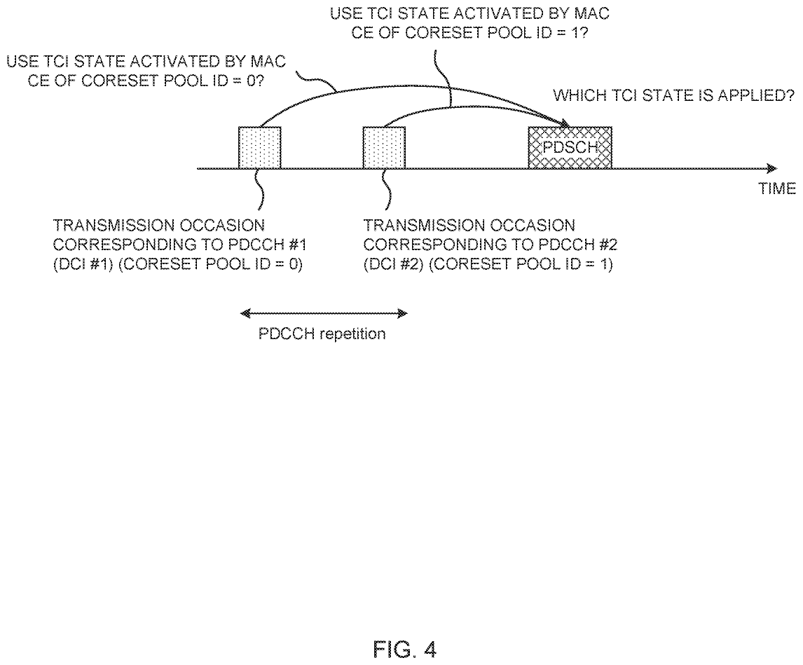

As shown in FIG. 4, it is also considered that two linked PDCCH candidates (for example, PDCCH #1 and PDCCH #2) for PDCCH repetition are respectively transmitted using two CORESETs having different CORESET pool IDs. For example, it is also assumed that PDCCH #1 corresponds to the first CORESET pool ID, and PDCCH #2 corresponds to the second CORESET pool ID.

In this manner, when the PDSCH is scheduled by a plurality of PDCCHs (for example, linked PDCCH candidates) corresponding to different CORESET pool IDs in PDCCH repetition transmission, how to control the TCI state to be applied to the PDSCH poses a problem.

For example, how the UE assumes/interprets mapping between the code points of the field for the TCI state in the DCI and the activated TCI states poses a problem. Alternatively, how the UE judges/determines the TCI state to be applied to the PDSCH based on the code point of the field for the TCI state in the DCI poses a problem.

Alternatively, when an offset between repeatedly transmitted PDCCHs (for example, a plurality of PDCCHs having different CORESET pool IDs) and the PDSCH scheduled by the plurality of PDCCHs is smaller than a given value, how to control the TCI state/QCL (for example, a default TCI state/default QCL) to be applied to the PDSCH poses a problem.

In view of this, the inventors of the present invention studied a control method when a shared channel (for example, a PDCCH/PUSCH) is scheduled by PDCCHs (or multi-PDCCH/DCI) to which repetition transmission is applied, and came up with the idea of the present embodiment.

In one aspect of the present disclosure, when one physical shared channel (for example, one PDSCH/PUSCH) is scheduled by a plurality of PDCCHs/DCIs supporting application of different CORESET pool IDs, the UE judges the TCI state corresponding to the physical shared channel, based on a field related to the TCI state (field for the TCI state) included in at least one of the plurality of DCIs.

Embodiments according to the present disclosure will be described in detail with reference to the drawings as follows. Respective aspects (configurations/radio communication methods shown in the respective aspects) may each be employed individually, or may be employed in combination.

In the present disclosure, “A/B” and “at least one of A and B” may be interchangeably interpreted. In the present disclosure, “A/B/C” and “at least one of A, B, and C” may be interchangeably interpreted. In the present disclosure, a cell, a serving cell, a CC, a carrier, a BWP, a DL BWP, a UL BWP, an active DL BWP, an active UL BWP, and a band may be interchangeably interpreted. In the present disclosure, an index, an ID, an indicator, and a resource ID may be interchangeably interpreted. In the present disclosure, to support, to control, to be able to control, to operate, and to be able to operate may be interchangeably interpreted.

In the present disclosure, configure, activate, update, indicate, enable, specify, and select may be interchangeably interpreted.

In the present disclosure, higher layer signaling may be, for example, any one of Radio Resource Control (RRC) signaling, Medium Access Control (MAC) signaling, broadcast information, and the like, or a combination of these. In the present disclosure, RRC, RRC signaling, an RRC parameter, a higher layer, a higher layer parameter, an RRC information element (IE), and an RRC message may be interchangeably interpreted.

As the MAC signaling, for example, a MAC control element (MAC CE), a MAC Protocol Data Unit (PDU), or the like may be used. The broadcast information may be, for example, a master information block (MIB), a system information block (SIB), minimum system information (Remaining Minimum System Information (RMSI)), other system information (OSI), or the like.

In the present disclosure, a MAC CE and an activation/deactivation command may be interchangeably interpreted.

In the present disclosure, a pool, a set, a group, a list, and a candidate may be interchangeably interpreted.

In the present disclosure, a DMRS, a DMRS port, and an antenna port may be interchangeably interpreted.

In the present disclosure, a special cell, an SpCell, a PCell, and a PSCell may be interchangeably interpreted.

In the present disclosure, a beam, a spatial domain filter, a space setting, a TCI state, a TCI assumption, a QCL assumption, a QCL parameter, quasi co-location, a spatial domain reception filter, a UE spatial domain reception filter, a UE receive beam, a DL beam, a DL receive beam, DL precoding, a DL precoder, a DL-RS, an RS of the QCL type D of a TCI state/QCL assumption, an RS of the QCL type A of a TCI state/QCL assumption, a spatial relation, a spatial domain transmission filter, a UE spatial domain transmission filter, a UE transmit beam, a UL beam, a UL transmit beam, UL precoding, a UL precoder, and a PL-RS may be interchangeably interpreted. In the present disclosure, a QCL type X-RS, a DL-RS associated with the QCL type X, a DL-RS having the QCL type X, a source of a DL-RS, an SSB, a CSI-RS, and an SRS may be interchangeably interpreted.

In the present disclosure, a TRP ID, a TRP-related ID, a CORESET pool ID, a position of one TCI state (an ordinal number, a first TCI state, or a second TCI state) out of two TCI states corresponding to one code point of a field in DCI, and a TRP may be interchangeably interpreted.

In the present disclosure, a TRP, a transmission point, a panel, a DMRS port group, a CORESET pool, and one of two TCI states associated with one code point of a TCI field may be interchangeably interpreted.

In the following description, description will be given by taking an example of a case in which details of the DCI (for example, DCI payload/coded bits/number of CCEs) transmitted on respective PDCCHs are the same in repetition transmission of the PDCCHs. For example, code points of the field for the TCI in DCI transmitted on a first PDCCH and code points of the field for the TCI in DCI transmitted on a second PDCCH may be configured to be the same. Note that the present embodiment is not limited to this, and may be applied to a case in which the code points of the DCIs are different.

(First Aspect)

In a first aspect, when scheduling of one physical shared channel is supported by a plurality of PDCCHs (or PDCCH candidates) corresponding to different CORESET pool IDs, the UE judges the TCI state by referring to one PDCCH candidate (or CORESET pool ID) for the PDSCH. Alternatively, the UE judges the TCI state of the PDSCH, based on the MAC CE corresponding to a specific CORESET pool ID.

In the present disclosure (or other aspects), the PDCCH (or the PDCCH candidate) may be interpreted as DCI (or a DCI candidate). In the present disclosure (or other aspects), regarding the physical shared channel, the PDSCH is taken as an example in description, but the present disclosure (or other aspects) may also be similarly applied with the PUSCH being taken as an example thereof.

The UE may receive information related to activation/deactivation of the TCI states. The information related to activation of the TCI states may be received using the MAC CE. As the MAC CE, the MAC CE (for example, TCI States Activation/Deactivation for UE-specific PDSCH MAC CE) used for reporting of activation of the TCI states for the PDSCH in the existing systems (for example, Rel. 16) may be used.

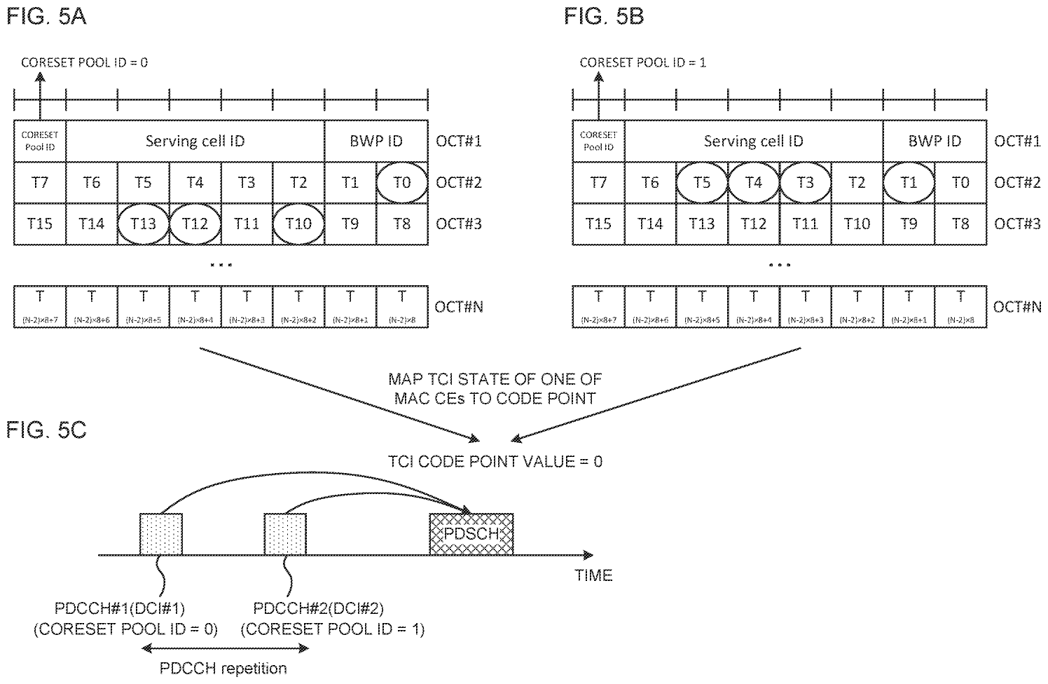

FIG. 5A and FIG. 5B each show an example of the MAC CE used for reporting of activation of the TCI states. FIG. 5A shows a case in which CORESET pool ID=0 is specified. FIG. 5A shows a case in which TCI states #0, #10, #12, and #13 are activated. Note that the activated TCI states are examples and are not limited to these.

FIG. 5B shows a case in which CORESET pool ID=1 is specified. FIG. 5B shows a case in which TCI states #1, #3, #4, and #5 are activated. Note that the activated TCI states are examples and are not limited to these.

A case is assumed in which one PDSCH is scheduled by associated (or linked) PDCCH candidates in two CORESETs having different CORESET pool IDs (see FIG. 5C). FIG. 5C shows a case in which one PDSCH is scheduled by PDCCH #1/DCI #1 (corresponding to CORESET pool ID #0) and PDCCH #2/DCI #2 (corresponding to CORESET pool ID #1). Here, a case is shown in which 0 (for example, “000”) is specified as the code point of the field for the TCI state in the DCI of each PDCCH. The code point of the field for the TCI state included in the DCI may be referred to as a TCI code point.

Regarding the PDSCH, when the TCI states activated by the MAC CE are mapped to the TCI code points in the DCI, one (or a specific) PDCCH candidate out of a plurality of PDCCH candidates may be referred to. To one PDCCH candidate (which may be referred to as a reference PDCCH candidate or a reference PDCCH) out of the plurality of PDCCH candidates, at least one of the following option 1-1 to option 1-6 may be applied.

<Option 1-1>

The PDCCH candidate corresponding to a first CORESET pool index (for example, #0) or the first CORESET pool ID may be referred to. A case in which the first CORESET pool ID is referred to may mean that the TCI state of the PDSCH associated with the first CORESET pool index is selected.

When the UE receives information (for example, the MAC CE of FIGS. 5A and 5B) related to the activated TCI states corresponding to each CORESET pool ID, the UE may apply the TCI states activated by the MAC CE corresponding to the first CORESET pool index (#0). In other words, the UE may assume that the TCI states activated by the MAC CE corresponding to the first CORESET pool index (#0) are mapped to the TCI code points of the DCI.

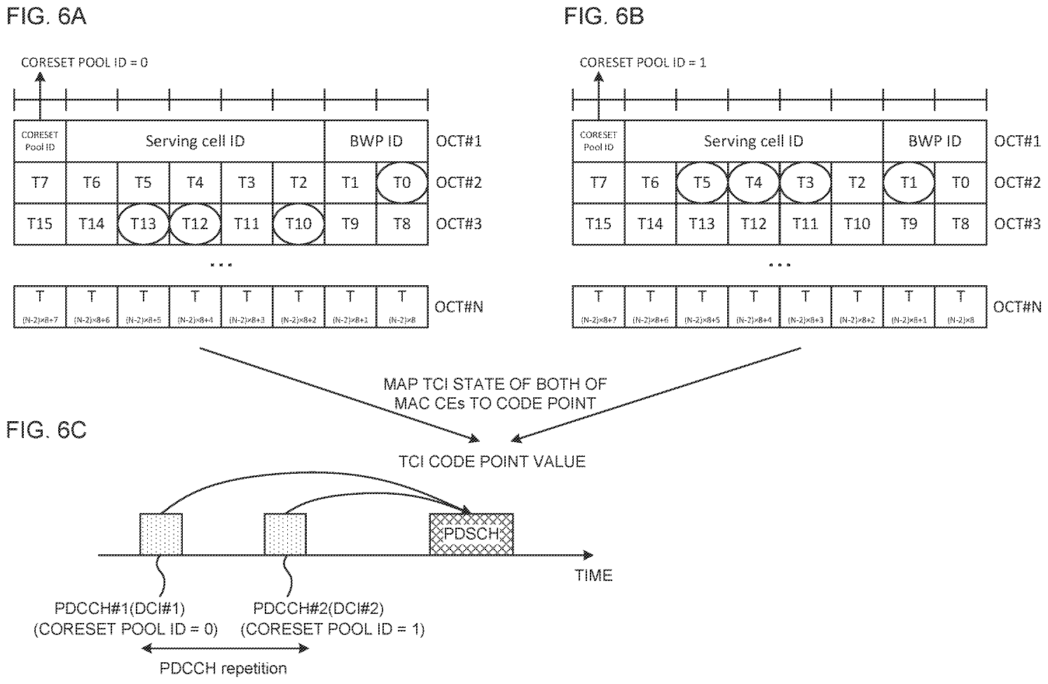

For example, TCI state #0 of which activation is indicated by the MAC CE (see FIG. 6A) corresponding to the first CORESET pool index (#0) may be mapped to the TCI code point “000”, and TCI state #10 may be mapped to the TCI code point “001”.

<Option 1-2>

When 0 (“000”) is specified as the TCI code point, the UE may apply TCI state #0 to the PDSCH. The PDCCH candidate corresponding to a second CORESET pool index (for example, #1) or the second CORESET pool ID may be referred to.

When the UE receives information (for example, the MAC CE of FIGS. 5A and 5B) related to the activated TCI states corresponding to each CORESET pool ID, the UE may apply the TCI states activated by the MAC CE corresponding to the second CORESET pool index (#1). In other words, the UE may assume that the TCI states activated by the MAC CE corresponding to the second CORESET pool index (#1) are mapped to the TCI code points.

For example, TCI state #1 of which activation is indicated by the MAC CE (see FIG. 6B) corresponding to the second CORESET pool index (#1) may be mapped to the TCI code point “000”, and TCI state #3 may be mapped to the TCI code point “001”. For example, when 0 (“000”) is specified as the TCI code point, the UE may apply TCI state #1 to the PDSCH.

<Option 1-3>

Of the plurality of PDCCH candidates (or the plurality of PDCCH monitoring occasions), the first PDCCH candidate (or the PDCCH candidate of the first PDCCH monitoring occasion) may be referred to. The “first” may mean the earliest transmission (or first reception by the UE) in the time domain, or may mean that an index of the monitoring occasion is the smallest.

Alternatively, of the plurality of PDCCH candidates (or the plurality of PDCCH monitoring occasions), the last PDCCH candidate (or the PDCCH candidate of the last PDCCH monitoring occasion) may be referred to. The “last” may mean the last transmission (or the last reception by the UE) in the time domain, or may mean that an index of the monitoring occasion is the largest.

The UE may determine the TCI state of the PDSCH by using the MAC CE specifying the CORESET pool ID corresponding to the first PDCCH candidate (or the last PDCCH candidate). For example, the UE may assume that the TCI states activated by the MAC CE are mapped to the TCI code points included in the DCI.

<Option 1-4>

The PDCCH candidate of the CORESET having the lowest CORESET ID may be referred to. Alternatively, the PDCCH candidate of the CORESET having the highest CORESET ID may be referred to.

The UE may determine the TCI state of the PDSCH by using the MAC CE specifying the CORESET pool ID configured to the CORESET having the lowest (or the highest) index. For example, the UE may assume that the TCI states activated by the MAC CE are mapped to the TCI code points included in the DCI.

<Option 1-5>

The PDCCH candidate of the CORESET having the lowest search space set ID may be referred to. Alternatively, the PDCCH candidate of the CORESET having the highest search space set ID may be referred to.

The UE may determine the TCI state of the PDSCH by using the MAC CE specifying the CORESET pool ID corresponding to the search space set having the lowest (or the highest) index. For example, the UE may assume that the TCI states activated by the MAC CE are mapped to the TCI code points included in the DCI.

<Option 1-6>

A method of determining the reference PDCCH candidate may be configured from the base station to the UE. For example, a plurality of options out of option 1-1 to option 1-5 may be supported, and which option is to be applied may be semi-statically or dynamically configured/indicated by higher layer signaling/MAC CE/DCI.

In the above options, a case in which one of linked PDCCH candidates is referred to may mean that the MAC CE for TCI state activation in which the CORESET pool ID is configured to the same CORESET pool ID as the reference PDCCH candidate is applied in mapping between the TCI code points included in the DCI and the activated TCI states.

A rule for determining criteria for TCI state indication may be matched with a rule for determining criteria for timing offset/HARQ codebook/DAI/PUCCH resource determination. Alternatively, the rule for determining criteria for TCI state indication may be different from the rule for determining criteria for timing offset/HARQ codebook/DAI/PUCCH resource determination.

In this manner, in the first aspect, mapping between the TCI states activated by referring to one (or a specific) PDCCH candidate out of a plurality of PDCCH candidates and the TCI code points is performed. With this, even when scheduling of one PDSCH is supported by a plurality of PDCCHs corresponding to different CORESET pool IDs, the TCI state to be applied to the PDSCH can be appropriately determined.

(Second Aspect)

In a second aspect, when scheduling of one physical shared channel is supported by a plurality of PDCCHs (or PDCCH candidates) corresponding to different CORESET pool IDs, the UE judges the TCI state by taking the MAC CE corresponding to each CORESET pool ID into consideration.

Regarding the PDSCH scheduled by PDCCH repetition having two different CORESET pool IDs, the UE may interpret mapping between the TCI states activated by the MAC CE and the TCI code points of the DCI with a new rule different from that of the existing systems.

For example, the UE may assume that both of the TCI state activated by the MAC CE corresponding to the first CORESET pool ID and the TCI state activated by the MAC CE corresponding to the second CORESET pool ID are mapped to the TCI code point.

The UE may receive information related to activation/deactivation of the TCI states. The information related to activation of the TCI states may be received using the MAC CE. As the MAC CE, the MAC CE (for example, TCI States Activation/Deactivation for UE-specific PDSCH MAC CE) used for reporting of activation of the TCI states for the PDSCH in the existing systems (for example, Rel. 16) may be used.

FIG. 6A and FIG. 6B each show an example of the MAC CE used for reporting of activation of the TCI states. FIG. 6A shows a case in which CORESET pool ID #0 is specified. FIG. 6A shows a case in which TCI states #0, #10,#12, and #13 are activated. Note that the activated TCI states are examples and are not limited to these.

FIG. 6B shows a case in which CORESET pool ID #1 is specified. FIG. 6B shows a case in which TCI states #1, #3, #4, and #5 are activated. Note that the activated TCI states are examples and are not limited to these.

A case is assumed in which one PDSCH is scheduled by associated (or linked) PDCCH candidates in two CORESETs having different CORESET pool IDs (see FIG. 6C). FIG. 6C shows a case in which one PDSCH is scheduled by PDCCH #1/DCI #1 (corresponding to CORESET pool ID #0) and PDCCH #2/DCI #2 (corresponding to CORESET pool ID #1).

Regarding the PDSCH, when the TCI states activated by the MAC CE are mapped to the TCI code points in the DCI, a plurality of MAC CEs respectively corresponding to different CORESET pool IDs may be taken into consideration. As a mapping rule, at least one of the following option 2-1 to option 2-2 may be applied.

<Option 2-1>

The TCI code points may be mapped to the first activated TCI states in order of the CORESET pool ID, and the same CORESET pool ID may be mapped in order of the TCI state ID.

For example, the first to (x+1)-th TCI states whose TCI state field (Ti field) of the MAC CE configured with the first CORESET pool ID (#0) is configured to ‘1’ may be mapped to TCI code point values 0 to x. The first to y-th TCI states whose TCI state field (Ti field) of the MAC CE configured with the second CORESET pool ID (#1) is configured to ‘1’ may be mapped to TCI code point values x+1 to x+y.

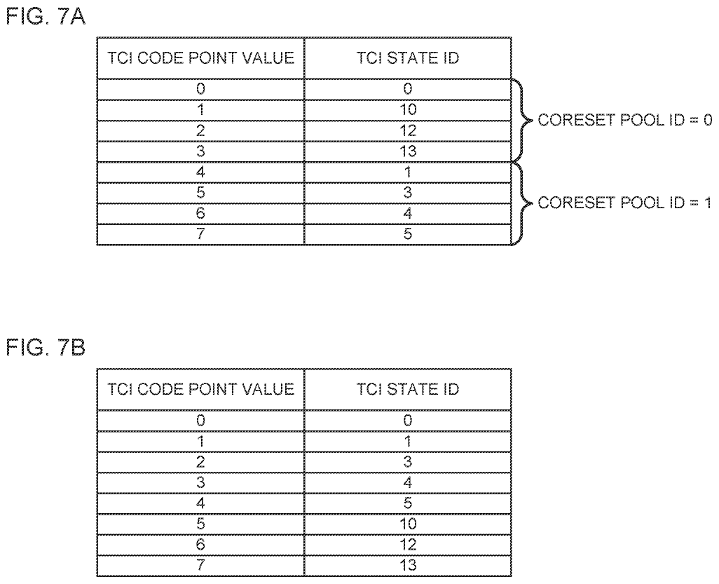

In the case shown in FIGS. 6A and 6B, TCI states #0, #10, #12, and #13 activated by the MAC CE corresponding to the first CORESET pool ID are respectively mapped to the TCI code points 0, 1, 2, and 3 (see FIG. 7A). TCI states #1, #3, #4, and #5 activated by the MAC CE corresponding to the second CORESET pool ID are respectively mapped to TCI code points 4, 5, 6, and 7.

FIG. 7A shows a case in which the number of TCI states activated by the MAC CE corresponding to the first CORESET pool ID and the number of TCI states activated by the MAC CE corresponding to the second CORESET pool ID are the same, but this is not restrictive.

<Option 2-2>

The TCI code points may be mapped to the activated TCI states in order of the TCI state ID.

For example, the TCI states whose TCI state field of the MAC CE configured with the first CORESET pool ID (#0) is configured to ‘1’ and the TCI states whose TCI state field of the MAC CE configured with the second CORESET pool ID (#1) is configured to ‘1’ may be mapped to TCI code point values 0 to x.

In the case shown in FIGS. 6A and 6B, TCI states #0, #10, #12, and #13 activated by the MAC CE corresponding to the first CORESET pool ID and TCI states #1, #3, #4, and #5 activated by the MAC CE corresponding to the second CORESET pool ID are respectively mapped to TCI code points 0 to 7 in order of the TCI state ID (see FIG. 7B).

FIG. 7B shows a case in which the number of TCI states activated by the MAC CE corresponding to the first CORESET pool ID and the number of TCI states activated by the MAC CE corresponding to the second CORESET pool ID are the same, but this is not restrictive.

In option 2-1/option 2-2, the size of the field for the TCI state may be configured to 3 bits. In this case, a maximum total number of TCI states activated by the MAC CE corresponding to the first CORESET pool ID and the second CORESET pool ID may be 8.

As the size of the field for the TCI state, a size larger than 3 bits (for example, 4 bits) may be applied. In this case, a maximum number of TCI states activated by the MAC CE corresponding to each CORESET pool ID may be 8.

Alternatively, a maximum total number of TCI states activated by the MAC CE corresponding to the first CORESET pool ID and the second CORESET pool ID may be configured to 8, and a maximum of four activated TCI states may be selected from the MAC CE for each CORESET pool ID. For example, when the number of TCI states activated in the MAC CE of first CORESET pool ID #0/#1 is larger than 4, first (or last) four TCI states whose TCI state field is configured to 1 may be mapped to the TCI code points of the DCI.

In a case of the PDSCH scheduled by a non-linked PDCCH, a rule of the existing systems in which eight activated TCI states by the MAC CE are mapped to the TCI code points of the DCI may be applied.

In this manner, in the second aspect, the TCI states respectively activated by the MAC CE in which different CORESET pool IDs are configured are mapped to the TCI code points. With this, the activated TCI states corresponding to different CORESET pool IDs can be specified using the DCI, and thus the TCI state to be applied to the PDSCH can be flexibly configured.

(Third Aspect)

In a third aspect, when scheduling of one physical shared channel is supported by a plurality of PDCCHs (or PDCCH candidates) corresponding to different CORESET pool IDs, the UE judges the TCI state by taking a MAC CE not corresponding to the CORESET pool ID (or a MAC CE not including a CORESET pool ID field) into consideration.

The UE may apply the TCI states activated by a new MAC CE regarding the PDSCH scheduled by PDCCH repetition having two different CORESET pool IDs. The new MAC CE may be defined/configured separately from the MAC CE of the existing systems (for example, the MAC CE having the CORESET pool ID field).

For example, the new MAC CE may not include a field specifying the CORESET pool ID. Regarding the PDSCH scheduled by PDCCH repetition having two different CORESET pool IDs, the UE may assume that the TCI states activated by the new MAC CE are mapped to the TCI code points.

The UE may receive information related to activation/deactivation of the TCI states. The information related to activation of the TCI states may be received using the MAC CE. The UE may assume both of the MAC CE (for example, TCI States Activation/Deactivation for UE-specific PDSCH MAC CE) used for reporting of activation of the TCI states for the PDSCH in the existing systems (for example, Rel. 16) and the new MAC CE. The new MAC CE (for example, Enhanced TCI States Activation/Deactivation for UE-specific PDSCH MAC CE) may be applied to only under a given condition (for example, when it is configured by higher layer signaling).

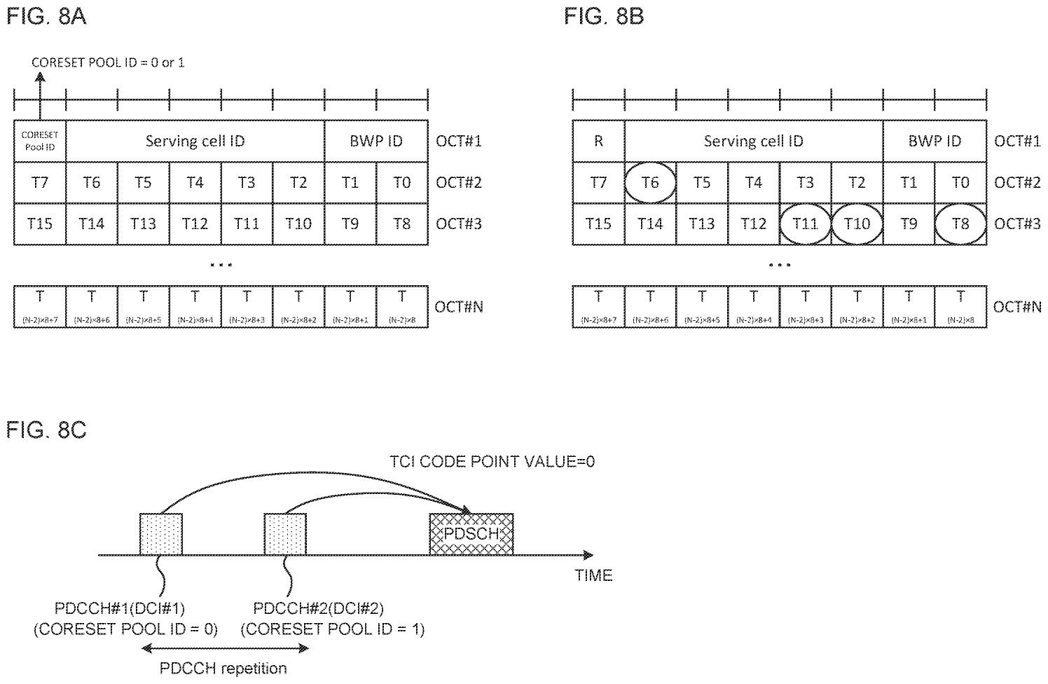

FIG. 8A and FIG. 8B each show an example of the MAC CE used for reporting of activation of the TCI states. FIG. 8A shows the MAC CE including a field for reporting the CORESET pool ID. Using the field, the first CORESET pool ID or the second CORESET pool ID may be configured.

FIG. 8B shows an example of the new MAC CE. The new MAC CE may not include the field for reporting the CORESET pool ID. FIG. 8B shows a case in which TCI states #6, #8, #10, and #11 are activated. Note that the activated TCI states are examples and are not limited to these.

A case is assumed in which one PDSCH is scheduled by associated (or linked) PDCCH candidates in two CORESETs having different CORESET pool indices (see FIG. 8C). FIG. 8C shows a case in which one PDSCH is scheduled by PDCCH #1/DCI #1 (corresponding to CORESET pool index #0) and PDCCH #2/DCI #2 (corresponding to CORESET pool index #1). Here, a case is shown in which 0 (for example, “000”) is specified as the TCI code point of the DCI of each PDCCH.

In this case, the UE may control reception of the PDSCH by taking the TCI states activated by the new MAC CE (see FIG. 8B) into consideration. For example, the UE may assume that the TCI states activated by the new MAC CE are mapped to the TCI code points of the DCI.

In the case shown in FIG. 8B, the UE may assume that TCI states #6, #8, #10, #11, . . . activated by the new MAC CE are respectively mapped to the TCI code points. For example, TCI state #6 may be mapped to TCI code point 0, TCI states #8, #10, #11, . . . may be respectively mapped to TCI code points 1, 2, 3, . . .

When 0 (“000”) is specified as the TCI code point, the UE may apply TCI state #6 to the PDSCH.

The MAC CE shown in FIG. 8A may be applied to the PDSCH scheduled by the PDCH with no repetition (or with no linkage with other PDCCH candidates/CORESETs/search space sets) or the PDSCH scheduled by a plurality of PDCCH candidates to which the same CORESET pool index is applied.

In this manner, the MAC CE (or the new MAC CE) for TCI state activation enhanced from Rel. 16 may be selectively applied to the PDSCH scheduled by two PDCCH candidates linked in two CORESETs having different CORESET pool IDs.

In the third aspect, when scheduling of one PDSCH is supported by a plurality of PDCCHs corresponding to different CORESET pool IDs, activation of the TCI states (or mapping between the activated TCI states and the TCI code points) can be performed using the new MAC CE. The TCI state to be applied to the PDSCH can be flexibly configured.

<Variation 1>

The new MAC CE may be used for activation of the TCI states of the PDSCH scheduled by PDCCH repetition of the PDCCH candidates linked in two CORESETs having different CORESET pool IDs and activation of the TCI states corresponding to a specific CORESET pool ID.

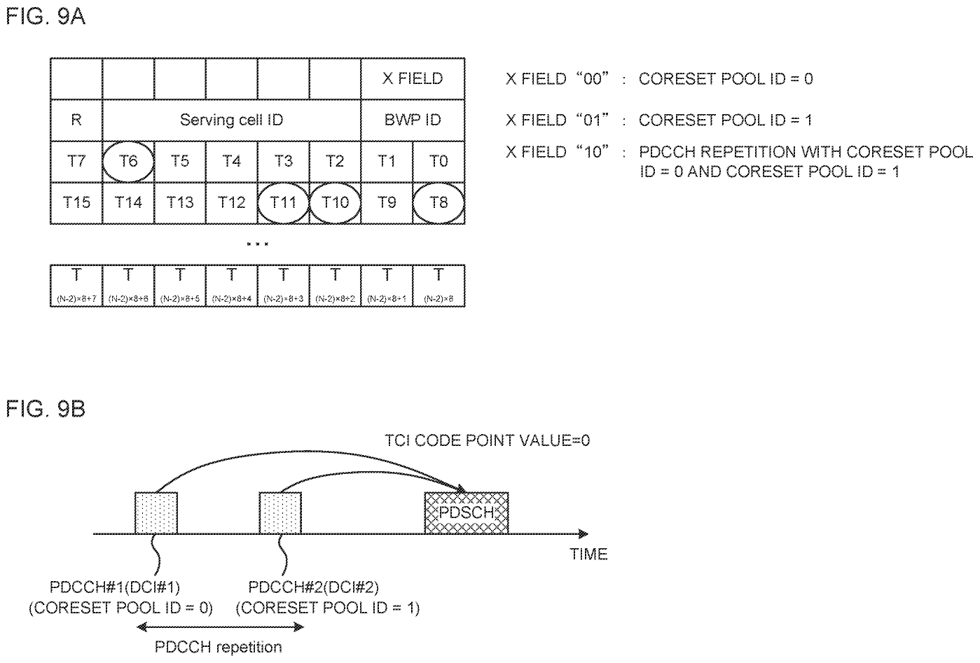

A given field (for example, X field) of the MAC CE may indicate CORESET pool ID=0 (“00”), CORESET pool ID=1 (“01”), or PDCCH repetition having different CORESET pool IDs (for example, PDCCH repetition with CORESETPoolID=0 and CORESETPoolID=1) (“10”) (see FIG. 9A). In this case, the UE may assume only the new MAC CE, and need not assume the existing MAC CE for TCI state activation.

FIG. 9A shows a case in which TCI states #6, #8, #10,and #11 are activated. Note that the activated TCI states are examples and are not limited to these.

A case is assumed in which the PDSCH is scheduled by two linked PDCCH candidates in two CORESETs having different CORESET pool IDs (see FIG. 9B). In this case, the TCI state activated by the MAC CE in which PDCCH repetition with CORESETPoolID=0 and CORESETPoolID=1 is configured in the X field may be mapped to the TCI code point of the DCI.

In the case shown in FIG. 9B, the UE may assume that TCI states #6, #8, #10, and #11, . . . activated by the new MAC CE are respectively mapped to TCI code points 0, 1, 2, 3, . . . . Here, 0 is reported as the code point of the field for the TCI state, and thus the UE may apply TCI state #6 to the PDSCH.

Assumed is a case of scheduling of the PDSCH scheduled by the PDCH with no repetition (or with no linkage with other PDCCH candidates) or the PDSCH with a plurality of PDCCH candidates to which the same CORESET pool index is applied. When the PDCCH corresponds to CORESET pool ID=0, the TCI states activated by the new MAC CE in which CORESET pool ID=0 is configured in the X field may be mapped to the TCI code points of the DCI. When the PDCCH corresponds to CORESET pool ID=1, the TCI states activated by the new MAC CE in which CORESET pool ID=1 is configured in the X field may be mapped to the TCI code points of the DCI.

<Variation 2>

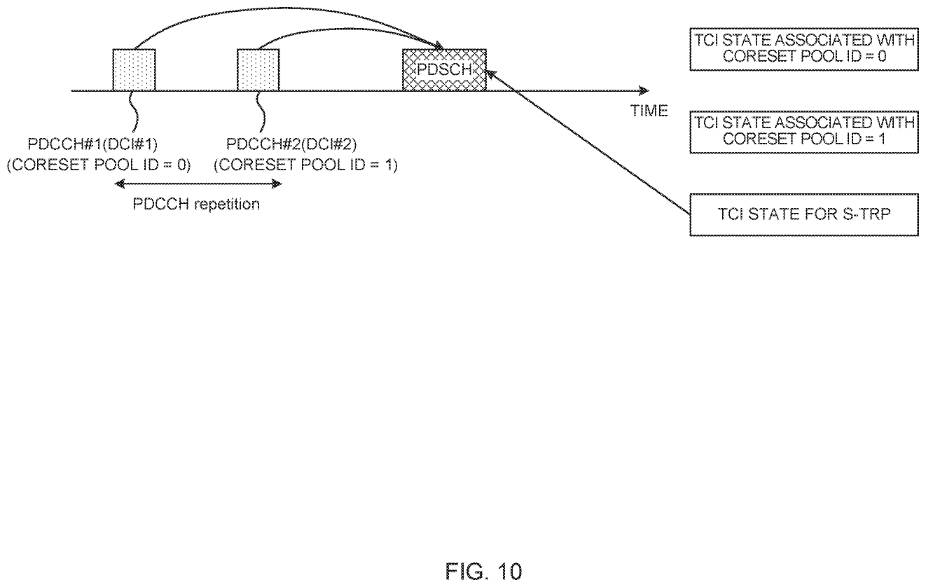

Both of the TCI state for the PDSCH of the single TRP (for example, TCI state for PDSCH for S-TRP) and the TCI state for the PDSCH of the multi-DCI-based multi-TRP (for example, TCI state for PDSCH or M-DCI M-TRP) may be configured. In this case, for the PDSCH scheduled by PDCCHs (for example, linked PDCCHs, repetition PDCCHs) associated with different CORESET pool IDs, the TCI state for the PDSCH of the single TRP may be selected (see FIG. 10).

(Fourth Aspect)

A fourth aspect will describe the TCI state/QCL assumption to be applied to the PDSCH when an offset (also referred to as a scheduling offset) between the PDCCH/DCI and the PDSCH scheduled by the PDCCH/DCI is smaller than a given value (for example, timeDurationForQCL) in PDCCH repetition.

In the existing systems (for example, Rel. 16), when the offset between the PDCCH/DCI and the PDSCH is smaller than the given value (for example, timeDurationForQCL), CORESETs having different CORESET pool IDs are configured, and a given higher layer parameter is configured, a given QCL may be applied to the PDSCH. The given higher layer parameter may be a higher layer parameter (for example, enableDefaultTCIStatePerCoresetPoolIndex-r16) for configuring the default TCI state for each CORESET pool index.

For example, regarding the PDSCH scheduled by the PDCCH of CORESET pool ID=0, the QCL of the CORESET having the smallest CORESET ID out of the CORESETs of CORESET pool ID=0 in the latest slot may be used as the default QCL of the PDSCH. The latest slot may be the most recent slot in which monitoring of the CORESET (for example, the CORESET corresponding to CORESET pool ID #0) is performed. In other words, the default TCI state/QCL of the PDSCH for CORESET pool ID=0 may be determined based on the smallest CORESET ID associated with CORESET pool ID=0 in the latest monitoring slot.

For example, regarding the PDSCH scheduled by the PDCCH of CORESET pool ID=1, the QCL of the CORESET having the smallest CORESET ID out of the CORESETs of CORESET pool ID=1 in the latest slot may be used as the default QCL of the PDSCH. The latest slot may be the most recent slot in which monitoring of the CORESET (for example, the CORESET corresponding to CORESET pool ID #1) is performed. In other words, the default TCI state/QCL of the PDSCH for CORESET pool ID=1 may be determined based on the smallest CORESET ID associated with CORESET pool ID=1 in the latest monitoring slot.

In this manner, in the existing systems, when the higher layer parameter for configuring the default TCI state for each CORESET pool index is configured, and the offset between the DCI and the PDSCH is smaller than the given value, the default QCL to be applied to the PDSCH is determined by taking the CORESET pool ID corresponding to the DCI (or the PDCCH) into consideration. In other words, the default QCL to be applied to the PDSCH is determined based on the CORESET pool ID corresponding to the PDCCH/DCI for scheduling the PDSCH.

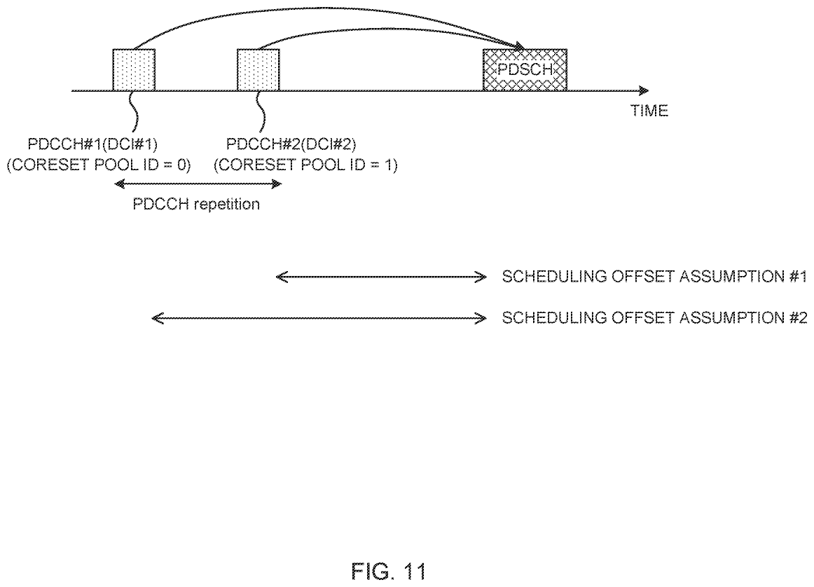

In contrast, it is also assumed that a plurality of PDCCH candidates (for example, linked PDCCH candidates) for PDCCH repetition are transmitted in two CORESETs having different CORESET pool IDs (see FIG. 11).

FIG. 11 shows an example of a case in which scheduling of one PDSCH (for example, the same PDSCH) is performed with repetition transmissions of the PDCCHs. A case in which PDCCH #1/DCI #1 corresponds to the first CORESET pool ID (here, #0) and PDCCH #2/DCI #2 corresponds to the second CORESET pool ID (here, #1) is shown. Here, a case in which the number of repetitions (or a repetition factor) of the PDCCHs is 2 is shown. However, the number of repetitions may be three or more.

In FIG. 11, when the scheduling offset between at least one (or all) of the repeatedly transmitted PDCCHs/DCIs and the PDSCH is smaller than the given value (for example, timeDurationForQCL), how to determine the default QCL (or a default beam) to be applied to the PDSCH poses a problem.

In the present embodiment, when the scheduling offset between at least one (or all) of the repeatedly transmitted PDCCHs/DCIs and the PDSCH is smaller than the given value, at least one of the following Alt. 4-1 to Alt. 4-3 may be applied. In the following description, application is possible for both of a case (scheduling offset assumption #1) in which the offset between at least one PDCCH/DCI and the PDSCH is smaller than the given value and a case (scheduling offset assumption #2) in which the offset between the plurality of PDCCHs/DCIs and the PDSCH is smaller than the given value, out of the repeatedly transmitted PDCCHs/DCIs.

In Alt. 4-1, when the scheduling offset between at least one (or all) of the repeatedly transmitted PDCCHs/DCIs and the PDSCH is smaller than the given value, control is performed so as not to perform configuration of the default TCI state for each CORESET pool ID. In Alt. 4-2/4-3, when the scheduling offset between at least one (or all) of the repeatedly transmitted PDCCHs/DCIs and the PDSCH is smaller than the given value, control is performed so as to perform configuration of the default TCI state for each CORESET pool ID.

<Alt. 4-1>

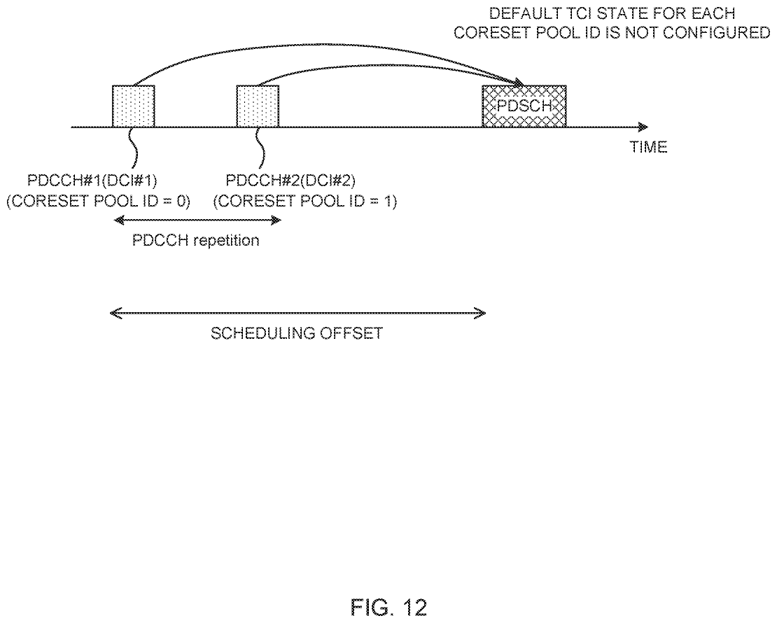

When a plurality of (for example, two) PDCCH candidates (for example, linked PDCCH candidates) for PDCCH repetition are configured in two CORESETs having different CORESET pool IDs, the UE need not assume that the given higher layer parameter (for example, enableDefaultTCIStatePerCoresetPoolIndex-r16) for configuring the default TCI state for each CORESET pool index is configured (see FIG. 12). In other words, when a plurality of linked PDCCH candidates for PDCCH repetition are transmitted in two CORESETs having different CORESET pool IDs, the UE may assume that the default TCI state is not configured for each CORESET pool index.

When the given higher layer parameter is not configured, and the offset between reception of the PDCCH/DCI and reception of its corresponding PDSCH is smaller than the given value, for the UE, the QCL of the CORESET having the smallest CORESET ID out of the CORESETs in the latest slot in which monitoring of the CORESET is performed may be used as the default QCL of the PDSCH, irrespective of the CORESET pool ID (or without the CORESET pool ID being taken into consideration).

In other words, the default TCI state/QCL of the PDSCH may be determined based on the smallest CORESET ID in the latest CORESET monitoring slot, without the CORESET pool ID being taken into consideration.

Note that, in the existing systems (for example, Rel. 16), the UE may apply a UE operation of a case in which the given higher layer parameter (for example, enableDefaultTCIStatePerCoresetPoolIndex-r16) is not configured.

The UE may assume that the DM-RS ports of the PDSCH of the serving cell are quasi co-located with the RS(s) with respect to the QCL parameter(s) used for PDCCH quasi co-location indication of the CORESET associated with a monitored search space having the smallest CORESET ID (for example, lowest controlResourceSetID) in the latest slot in which one or a plurality of CORESETs within the active BWP of the serving cell are monitored by the UE (the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE.).

<Alt. 4-2>

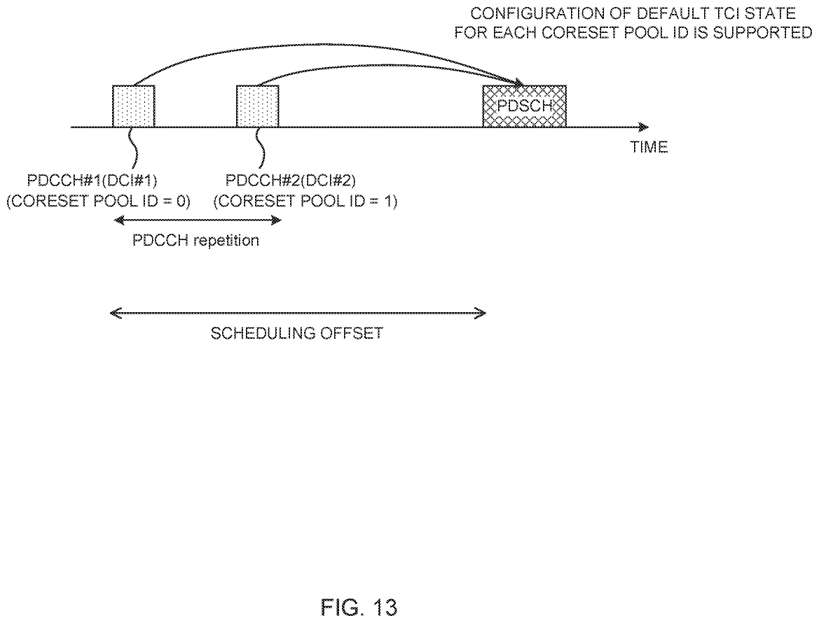

When a plurality of (for example, two) PDCCH candidates (for example, linked PDCCH candidates) for PDCCH repetition are configured in two CORESETs having different CORESET pool IDs, for the UE, a configuration of the given higher layer parameter for configuring the default TCI state for each CORESET pool index may be supported (see FIG. 13). In other words, when a plurality of linked PDCCH candidates for PDCCH repetition are transmitted in two CORESETs having different CORESET pool IDs, the UE may assume that the configuration of the default TCI state for each CORESET pool index is supported.

The given higher layer parameter for configuring the default TCI state for each CORESET pool index may be, for example, enableDefaultTCIStatePerCoresetPoolIndex-r16, or may be a new higher layer parameter.

A case is assumed in which the given higher layer parameter is configured, and the offset between reception of the PDCCH/DCI and reception of its corresponding PDSCH is smaller than the given value (see FIG. 13). In this case, regarding the PDSCH scheduled by linked PDCCH candidates in two CORESETs having different CORESET pool IDs, the UE may determine the default QCL/default beam by referring to one (or a specific) PDCCH candidate out of the linked PDCCH candidates.

To one PDCCH candidate (which may be referred to as a reference PDCCH candidate or a reference PDCCH) out of the plurality of PDCCH candidates, at least one of the following option 4-2-1 to option 4-2-6 may be applied.

[Option 4-2-1]

The PDCCH candidate corresponding to a first CORESET pool index (for example, #0) or the first CORESET pool ID may be referred to. A case in which the first CORESET pool ID is referred to may mean that the TCI state of the PDSCH is the TCI state/QCL assumption of the smallest CORESET ID associated with CORESET pool ID=0 in the latest slot.

Regarding the PDSCH scheduled by repetition PDCCHs, the UE may assume that the QCL of the CORESET having the smallest CORESET ID out of the CORESETs of CORESET pool ID=0 in the latest slot is the default QCL of the PDSCH. The latest slot may be the most recent slot in which monitoring of the CORESET (for example, the CORESET corresponding to CORESET pool ID #0) is performed.

[Option 4-2-2]

The PDCCH candidate corresponding to a second CORESET pool index (for example, #1) or the second CORESET pool ID may be referred to. A case in which the second CORESET pool ID is referred to may mean that the TCI state of the PDSCH is the TCI state/QCL assumption of the smallest CORESET ID associated with CORESET pool ID=1 in the latest slot.

Regarding the PDSCH scheduled by repetition PDCCHs, the UE may assume that the QCL of the CORESET having the smallest CORESET ID out of the CORESETs of CORESET pool ID=1 in the latest slot is the default QCL of the PDSCH. The latest slot may be the most recent slot in which monitoring of the CORESET (for example, the CORESET corresponding to CORESET pool ID #1) is performed.

[Option 4-2-3]

Of the plurality of PDCCH candidates (or the plurality of PDCCH monitoring occasions), the first PDCCH candidate (or the PDCCH candidate of the first PDCCH monitoring occasion) may be referred to. The “first” may mean the earliest transmission (or first reception by the UE) in the time domain, or may mean that an index of the monitoring occasion is the smallest.

Alternatively, of the plurality of PDCCH candidates (or the plurality of PDCCH monitoring occasions), the last PDCCH candidate (or the PDCCH candidate of the last PDCCH monitoring occasion) may be referred to. The “last” may mean the last transmission (or the last reception by the UE) in the time domain, or may mean that an index of the monitoring occasion is the largest.

A case of CORESET pool ID=0 corresponding to the first PDCCH candidate (or the last PDCCH candidate) is assumed. In this case, regarding the PDSCH scheduled by repetition PDCCHs, the UE may assume that the QCL of the CORESET having the smallest CORESET ID out of the CORESETs of CORESET pool ID=0 in the latest slot is the default QCL of the PDSCH.

A case of CORESET pool ID=1 corresponding to the first PDCCH candidate (or the last PDCCH candidate) is assumed. In this case, regarding the PDSCH scheduled by repetition PDCCHs, the UE may assume that the QCL of the CORESET having the smallest CORESET ID out of the CORESETs of CORESET pool ID=1 in the latest slot is the default QCL of the PDSCH.

[Option 4-2-4]

The PDCCH candidate of the CORESET having the lowest CORESET ID may be referred to. Alternatively, the PDCCH candidate of the CORESET having the highest CORESET ID may be referred to.

A case of CORESET pool ID=0 corresponding to the PDCCH candidate of the CORESET having the lowest (or the highest) CORESET ID is assumed. In this case, regarding the PDSCH scheduled by repetition PDCCHs, the UE may assume that the QCL of the CORESET having the smallest CORESET ID out of the CORESETs of CORESET pool ID=0 in the latest slot is the default QCL of the PDSCH.

A case of CORESET pool ID=1 corresponding to the PDCCH candidate of the CORESET having the lowest (or the highest) CORESET ID is assumed. In this case, regarding the PDSCH scheduled by repetition PDCCHs, the UE may assume that the QCL of the CORESET having the smallest CORESET ID out of the CORESETs of CORESET pool ID=1 in the latest slot is the default QCL of the PDSCH.

[Option 4-2-5]

The PDCCH candidate of the CORESET having the lowest search space set ID may be referred to. Alternatively, the PDCCH candidate of the CORESET having the highest search space set ID may be referred to.

A case of CORESET pool ID=0 corresponding to the PDCCH candidate of the CORESET having the lowest (or the highest) search space set ID is assumed. In this case, regarding the PDSCH scheduled by repetition PDCCHs, the UE may assume that the QCL of the CORESET having the smallest CORESET ID out of the CORESETs of CORESET pool ID=0 in the latest slot is the default QCL of the PDSCH.

A case of CORESET pool ID=1 corresponding to the PDCCH candidate of the CORESET having the lowest (or the highest) search space set ID is assumed. In this case, regarding the PDSCH scheduled by repetition PDCCHs, the UE may assume that the QCL of the CORESET having the smallest CORESET ID out of the CORESETs of CORESET pool ID=1 in the latest slot is the default QCL of the PDSCH.

[Option 4-2-6]

A method of determining the reference PDCCH candidate may be configured from the base station to the UE. For example, a plurality of options out of option 4-2-1 to option 4-2-5 may be supported, and which option is to be applied may be semi-statically or dynamically configured/indicated by higher layer signaling/MAC CE/DCI.

In the above options, a case in which the default QCL is determined by referring to one of linked PDCCH candidates may mean that the QCL of the CORESET having the smallest CORESET ID out of the CORESETs of the CORESET pool ID in the latest slot is determined as the default QCL of the PDSCH by taking the CORESET pool ID corresponding to the PDCCH candidate being referred to into consideration.

Specifically, the UE may assume that the DM-RS ports of the PDSCH scheduled by two linked PDCCH candidates associated with different CORESET pool IDs are quasi co-located with the RS(s) with respect to QCL parameter(s) used for PDCCH quasi co-location indication of the CORESET associated with a monitored search space having the smallest CORESET ID among CORESETs configured with the same CORESET pool ID as the “reference PDCCH candidate” between the two linked PDCCH candidates for scheduling the PDSCH in the latest slot in which one or a plurality of CORESETs associated with the same CORESET pool ID as the “reference PDCCH candidate” between the two linked PDCCH candidates for scheduling the PDSCH within the active BWP of the serving cell are monitored by the UE (the UE may assume that the DM-RS ports of PDSCH scheduled by two linked PDCCH candidates associated with different CORESETPoolID are quasi co-located with the RS(s) with respect to the QCL parameter(s) used for PDCCH quasi co-location indication of the CORESET associated with a monitored search space with the lowest controlResourceSetId among CORESETs, which are configured with the same value of CORESETPoolIndex as the “reference PDCCH candidate” between the two linked PDCCH candidates scheduling that PDSCH, in the latest slot in which one or more CORESETs associated with the same value of CORESETPoolIndex as the “reference PDCCH candidate” between the two linked PDCCH candidates scheduling that PDSCH within the active BWP of the serving cell are monitored by the UE.).

A rule for determining criteria for TCI state indication may be matched with a rule for determining criteria for timing offset/HARQ codebook/DAI/PUCCH resource determination. Alternatively, the rule for determining criteria for TCI state indication may be different from the rule for determining criteria for timing offset/HARQ codebook/DAI/PUCCH resource determination.

<Alt. 4-3>

When a plurality of (for example, two) PDCCH candidates (for example, linked PDCCH candidates) for PDCCH repetition are configured in two CORESETs having different CORESET pool IDs, for the UE, a configuration of the given higher layer parameter for configuring the default TCI state for each CORESET pool index may be supported (see FIG. 13). In other words, when a plurality of linked PDCCH candidates for PDCCH repetition are transmitted in two CORESETs having different CORESET pool IDs, the UE may assume that the configuration of the default TCI state for each CORESET pool index is supported.

The given higher layer parameter for configuring the default TCI state for each CORESET pool index may be, for example, enableDefaultTCIStatePerCoresetPoolIndex-r16, or may be a new higher layer parameter.

A case is assumed in which the given higher layer parameter is configured, and the offset between reception of the PDCCH/DCI and reception of its corresponding PDSCH is smaller than the given value (see FIG. 13). In this case, based on the CORESET having the smallest ID out of the CORESETs configured for PDCCH repetition and linked with another CORESET having a different CORESET pool ID, the UE may determine the QCL/default beam (or apply the TCI state/QCL corresponding to the CORESET as the default QCL/default beam).

For example, a case in which the PDSCH is scheduled by PDCCH #1/DCI #1 corresponding to CORESET pool ID=0 and PDCCH #2/DCI #2 corresponding to CORESET pool ID=1 is assumed. The UE may apply the TCI state/QCL corresponding to the CORESET having the smallest ID out of the CORESET corresponding to PDCCH #1 and the CORESET corresponding to PDCCH #2 as the default QCL/default beam of the PDSCH.

Specifically, the UE may assume that the DM-RS ports of the PDSCH scheduled by two linked PDCCH candidates associated with different CORESET pool IDs are quasi co-located with the RS(s) with respect to the QCL parameter(s) used for PDCCH quasi co-location indication of the CORESET associated with a monitored search space having the smallest CORESET ID (for example, lowest controlResourceSetID) among CORESETs configured with linkage with another CORESET having a different CORESET pool ID for PDCCH repetition in the latest slot in which one or a plurality of CORESETs configured with linkage with another CORESET having a different CORESET pool ID for PDCCH repetition within the active BWP of the serving cell are monitored by the UE (the UE may assume that the DM-RS ports of PDSCH scheduled by two linked PDCCH candidates associated with different CORESETPoolID are quasi co-located with the RS(s) with respect to the QCL parameter(s) used for PDCCH quasi co-location indication of the CORESET associated with a monitored search space with the lowest controlResourceSetId among CORESETs, which are configured with linkage with another CORESET with different CORESETPoolID for PDCCH repetition, in the latest slot in which one or more CORESETs configured with linkage with another CORESET with different CORESETPoolID for PDCCH repetition that within the active BWP of the serving cell are monitored by the UE.).

Alternatively, when the given higher layer parameter is configured, and the offset between reception of the PDCCH/DCI and reception of its corresponding PDSCH is smaller than the given value, for the UE, the QCL of the CORESET having the smallest CORESET ID out of the CORESETs in the latest slot in which monitoring of the CORESET is performed may be used as the default QCL of the PDSCH. The latest slot may be the most recent slot in which monitoring of the CORESET (for example, the CORESET corresponding to CORESET pool ID #0/#1) is performed.

For example, a case is assumed in which the offset between at least one (for example, PDCCH #2 in FIG. 13) of the repeatedly transmitted PDCCHs/DCIs and the PDSCH is smaller than the given value (case in which the offset between PDCCH #1 and the PDSCH is the given value or larger). In this case, the UE may determine the default TCI state/QCL to be applied to the PDSCH, based on the TCI state/QCL corresponding to PDCCH #1 (CORESET pool ID=0). For example, the TCI state/QCL corresponding to PDCCH #1 (CORESET pool ID=0) may be used as the default TCI state/QCL.

(UE Capability Information)

In the first aspect to the fourth aspect, the following UE capabilities may be configured. Note that the following UE capabilities may be interpreted as parameters (for example, higher layer parameters) configured from a network (for example, the base station) to the UE.

UE capability information related to whether or not PDCCH repetition of the multi-TRP (for example, M-TRP) is supported may be defined.

UE capability information related to whether or not PDCCH repetition of the multi-TRP using the PDCCH candidates linked in two CORESETs having different CORESET pool IDs is supported may be defined.

When the scheduling offset is smaller than the given value (for example, timeDurationForQCL), UE capability information related to whether or not the default QCL/default beam is supported for the PDSCH scheduled by PDCCH repetition in two CORESETs having different CORESET pool IDs may be defined.

The first aspect to the fourth aspect may be applied to the UE that supports/reports at least one of the UE capabilities described above. Alternatively, the first aspect to the fourth aspect may be applied to the UE configured with a corresponding higher layer parameter from the network.

(Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

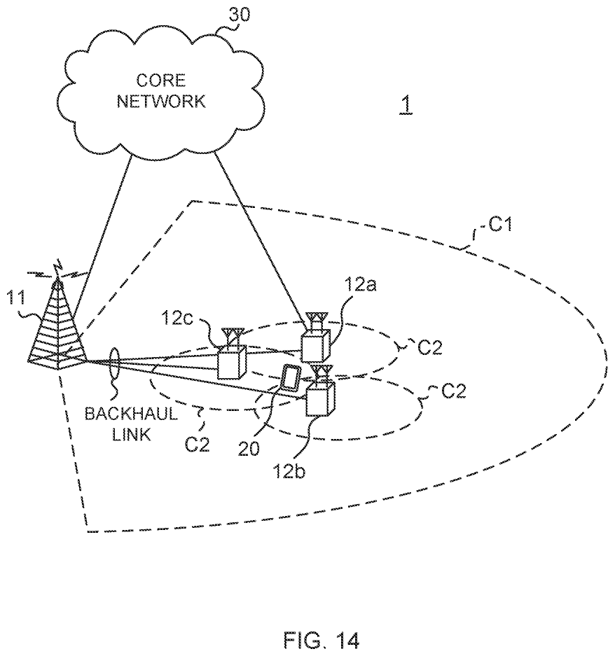

FIG. 14 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

(Base Station)

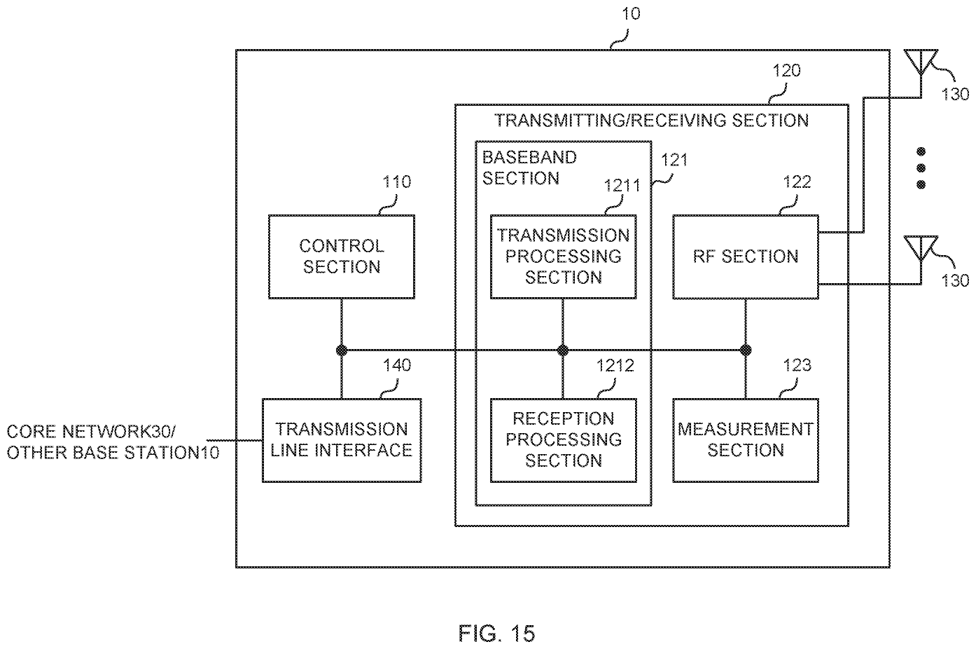

FIG. 15 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit a MAC CE including information related to activation of a transmission configuration indication (TCI) state of a physical shared channel. When one physical shared channel is scheduled by a plurality of downlink control channels supporting application of different control resource set pool indices, the control section 110 may indicate the TCI state corresponding to the physical shared channel by using a field related to the TCI state included in at least one of a plurality of downlink control information (DCI) respectively transmitted on the plurality of downlink control channels.

The transmitting/receiving section 120 may transmit, to the terminal, one physical shared channel scheduled by the plurality of downlink control channels supporting application of different control resource set pool indices. The control section 110 may, when an offset between at least one of the plurality of downlink control channels and the physical shared channel is smaller than a given value, judge that the physical shared channel is received in the terminal, based on a default TCI state configured for each of the control resource set pool indices or the default TCI state configured irrespective of the control resource set pool indices.

(User Terminal)

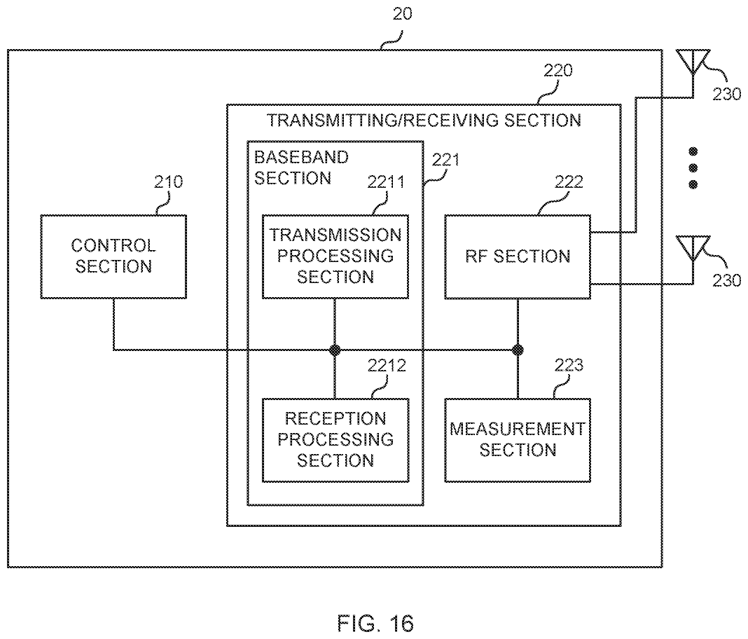

FIG. 16 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive a MAC CE including information related to activation of a transmission configuration indication (TCI) state of a physical shared channel.

When one physical shared channel is scheduled by a plurality of downlink control channels supporting application of different control resource set pool indices, the control section 210 may judge the TCI state corresponding to the physical shared channel, based on a field related to the TCI state included in at least one of a plurality of downlink control information (DCI) respectively transmitted on the plurality of downlink control channels.

A code point included in the field related to the TCI state may be related to the TCI state activated by the MAC CE corresponding to a specific control resource set pool index. Alternatively, the code point included in the field related to the TCI state may be related to the TCI state activated by the MAC CE corresponding to a first control resource set pool index and the TCI state activated by the MAC CE corresponding to a second control resource set pool index. Alternatively, the code point included in the field related to the TCI state may be related to the TCI state activated by the MAC CE not including information related to a control resource set pool index.

The transmitting/receiving section 220 may receive a plurality of downlink control channels supporting application of different control resource set pool indices.

The control section 210 may, when an offset between at least one of the plurality of downlink control channels and a physical shared channel scheduled by the plurality of downlink control channels is smaller than a given value, control reception of the physical shared channel, based on a default TCI state configured for each of the control resource set pool indices or the default TCI state configured irrespective of the control resource set pool indices.

The control section 210 may judge quasi co-location of the physical shared channel, based on a specific control resource set out of control resource sets having been monitored in a most recent slot in which the control resource sets are monitored. Alternatively, the control section 210 may judge quasi co-location of the physical shared channel, based on a specific control resource set corresponding to a control resource pool index of a specific downlink control channel out of the plurality of downlink control channels. Alternatively, the control section 210 may judge quasi co-location of the physical shared channel, based on a specific control resource set out of control resource sets corresponding to at least one of the plurality of downlink control channels.

(Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

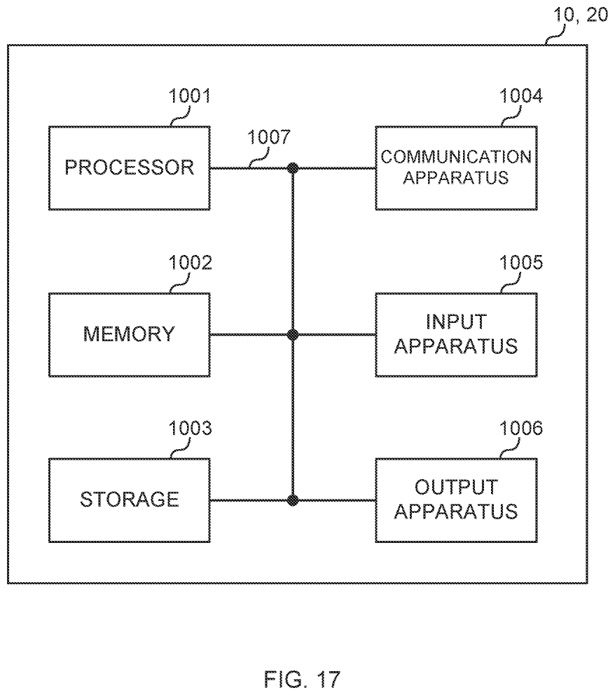

For example, a base station, a user terminal, and so on according to one embodiment of the present disclosure may function as a computer that executes the processes of the radio communication method of the present disclosure. FIG. 17 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAN), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

(Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmission power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given channel/signal outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (Li control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmission power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (U4B), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives a plurality of downlink control channels supporting application of different control resource set pool indices; and
a control section that, when an offset between at least one of the plurality of downlink control channels and a physical shared channel scheduled by the plurality of downlink control channels is smaller than a given value, controls reception of the physical shared channel, based on a default TCI state configured for each of control resource set pool indices or the default TCI state configured irrespective of control resource set pool indices.

2. The terminal according to claim 1, wherein
the control section judges quasi co-location of the physical shared channel, based on a specific control resource set out of control resource sets having been monitored in a most recent slot in which the control resource sets are monitored.

3. The terminal according to claim 1, wherein
the control section judges quasi co-location of the physical shared channel, based on a specific control resource set corresponding to a control resource pool index of a specific downlink control channel out of the plurality of downlink control channels.

4. The terminal according to claim 1, wherein
the control section judges quasi co-location of the physical shared channel, based on a specific control resource set out of control resource sets corresponding to at least one of the plurality of downlink control channels.

5. A radio communication method for a terminal, the radio communication method comprising:
receiving a plurality of downlink control channels supporting application of different control resource set pool indices; and
when an offset between at least one of the plurality of downlink control channels and a physical shared channel scheduled by the plurality of downlink control channels is smaller than a given value, controlling reception of the physical shared channel, based on a default TCI state configured for each of control resource set pool indices or the default TCI state configured irrespective of control resource set pool indices.

6. A base station comprising:
a transmitting section that transmits, to a terminal, one physical shared channel scheduled by a plurality of downlink control channels supporting application of different control resource set pool indices; and
a control section that, when an offset between at least one of the plurality of downlink control channels and the physical shared channel is smaller than a given value, judges that the physical shared channel is received in the terminal, based on a default TCI state configured for each of control resource set pool indices or the default TCI state configured irrespective of control resource set pool indices.
